(19) United States
(12) Patent Application Publication
(10) Pub. No.: US 2010/0308945 A1
(43) Pub. Date: Dec. 9, 2010

(54) Method of Positioning an Organic, Biological and/or Medical Specimen

(75) Inventors: Roman Zantl, Baldham (DE); Helga Wagner, Munchen (DE)

Correspondence Address: IP STRATEGIES, 12 1/2 WALL STREET, SUITE E, ASHEVILLE, NC, 28801, US

(73) Assignee: IBIDI GMBH, Martinsried (DE)

(21) Appl. No.: 12/779,353

(22) Filed: May 13, 2010

(30) Foreign Application Priority Data
May 13, 2009 (EP) 09006469.2

(51) Int. Cl. H01F 7/00

(52) U.S. Cl. 335/219

(57) ABSTRACT

The invention relates to a method of positioning an organic, biological and/or medical specimen in a desired surface region of a specimen carrier, whereby a magnet device is provided, comprising the steps joining the specimen with one or a plurality of magnetic, in particular paramagnetic particles, arrangement of the magnet device relative to the specimen carrier so that a desired magnetic field arrangement is provided in a predetermined region of the specimen carrier, introduction of the specimen into the specimen carrier and arrangement of the specimen in the desired surface region with the aid of the magnet device.

### CROSS-REFERENCE TO RELATED APPLICATION

This claims priority under 35 USC §119 of pending European Patent Application No. EP 09006469.2, which was filed on May 13, 2009, the entirety of which is incorporated herein by reference.

The invention relates to a method of positioning an organic, biological and/or medical specimen in a desired surface region of a specimen carrier. In particular the invention relates to a method of positioning a specimen with the aid of a magnet device.

### BACKGROUND OF THE INVENTION

Specimen carriers are used, in particular, in the fields of cell biology and medicine for the examination of organic, biological and/or medical specimens. In most experiments it is of advantage if the specimen can be precisely positioned. This enables the experiments to be conducted efficiently, improves the comparability of a plurality of experiments and simplifies the evaluation.

Often when filling a specimen carrier a random arrangement of the specimens occurs. The specimen positioning usually depends on the geometry of the specimen carrier as well as the type of filling. In certain cases the geometry of a specimen carrier is formed such that it is counter-productive with respect to a desired specimen positioning.

### BRIEF SUMMARY OF THE INVENTION

Therefore, the object of the invention is to provide a method of positioning an organic, biological and/or medical specimen, which facilitates the specimen to be positioned in a desired surface region of the specimen carrier.

This object is solved by a method according to claim 1.

The method according to the invention of positioning an organic, biological and/or medical specimen in a desired surface region of a specimen carrier, whereby a magnet device is provided, comprises the steps:

joining the specimen with one or a plurality of magnetic, in particular paramagnetic particles,
arrangement of the magnet device relative to the specimen carrier so that a desired magnetic field arrangement is provided in a predetermined region of the specimen carrier,
introduction of the specimen into the specimen carrier, and
arrangement of the specimen in the desired surface region with the aid of the magnet device.

This method facilitates precise specimen positioning in a desired surface region of the specimen carrier.

The organic, biological and/or medical specimen can be a biological cell. In particular the method can be carried out for a plurality of cells. In this way a desired cell distribution in a desired surface region of the specimen carrier can be achieved. In this case the cells can be introduced into the specimen carrier in the form of a suspension. In addition the specimen can be a micro-organism or DNA.

The specimen carrier can comprise a plastic, in particular COC (cyclo-olefin copolymer), COP (cyclo-olefin polymer), PS (polystyrene), PC (polycarbonate) or PMMA (polymethylmetacrylate). The specimen carrier can be formed as an injection moulded part. The specimen carrier can comprise a bottom plate, in particular whereby the specimen carrier lies on the bottom plate in operation, and whereby the bottom plate can comprise a plastic and/or glass. The bottom plate can be thin, for example between 1 μm and 300 μm. In this way high resolution microscopy through the bottom plate can be facilitated.

The specimen carrier can be dimensioned such that the volume of a cavity lies in the region of 5 μl to 1000 μl, in particular between 100 μl and 500 μl. Thus, the specimen carrier can be used for micro-fluidic examinations.

The specimen carrier can comprise a cover plate, whereby the cover plate is joined, in particular directly, to the bottom plate in a manner sealed to fluids.

The bottom plate and/or the cover plate can have a predetermined intrinsic fluorescence, which is lower than or equal to the intrinsic fluorescence of COC or COP or a conventional cover slip, and/or a predetermined refractive index, in particular >1.2 and/or <1.7. In particular the intrinsic fluorescence can be lower than or equal to the intrinsic fluorescence of a conventional cover slip (for example pure white glass in the hydrolytic class 1 (such as Menzel cover slips, in particular with the thickness no. 1.5)). The predetermined refractive index can in particular be >1.2 and/or <1.7. With a high quality material of this nature microscopic examinations can be carried out in an advantageous way. For example, the double refraction can be, so low that DIC (Differential Interference Contrast) is possible. A low intrinsic fluorescence facilitates carrying out fluorescence measurements.

In particular the bottom plate and/or cover plate can have an anti-reflection coating for a frequency range of electromagnetic radiation used in microscopy. In this way the transmission through the bottom plate and/or cover plate can be increased so that single-molecule measurements are possible with the aid of fluorescence.

The specimen carrier can comprise at least one surface region for the arrangement of a specimen, in particular whereby the surface region is arranged on the bottom plate. The specimen carrier can comprise a cavity for the accommodation of a specimen. At least one opening can lead to the cavity for filling the cavity with the specimen and/or a liquid or emptying it of same. The cavity can be formed by recesses in the cover plate and/or in the bottom plate.

By joining the specimen with one or a plurality of magnetic, in particular paramagnetic particles, specimens, which have no intrinsic magnetic moment, can be positioned with the aid of the magnet device. If the specimen involves a living cell, the magnetic particles can consist of a material which does not have any toxic effect on the cell.

The arrangement of the specimen can comprise aligning the specimen in the desired magnetic field arrangement. In particular the specimen can align through the action of the magnetic force of the desired magnetic field arrangement. In particular the specimen can move as a consequence of the action of the magnetic force and an arrangement of the specimen can be achieved in this way.

The arrangement of the specimen can comprise a movement of the magnet device relative to the specimen carrier. In this case a specimen, which has been brought into a predetermined region of the specimen carrier, can be arranged in a desired surface region. This can in particular be of advantage if the desired surface region is located in a region of the specimen carrier which is externally inaccessible or is difficult to access. In particular the specimen can be aligned in the desired magnetic field arrangement and then moved into the desired surface region through the action of the magnetic force by moving the magnet device.

The predetermined region of the specimen carrier can comprise the desired surface region. In this case the arrangement of the specimen can only occur by aligning the specimen in the desired magnetic field arrangement.

The desired magnetic field arrangement can comprise a magnetic field, a magnetic flux and/or a magnetic field line distribution. In particular the magnet device can provide a magnetic field, whereby the magnetic field, in particular the desired arrangement of the magnetic field or the desired magnetic field arrangement in the predetermined region, can be characterised by a magnetic field strength, a magnetic flux and/or a magnetic field line distribution.

The magnetic field (B) corresponds to a vector quantity and is also designated as magnetic induction or magnetic flux density. The magnetic field is proportional to the magnetic field strength (H), which is also designated as magnetizing field.

The predetermined region of the specimen carrier can comprise a surface region of the specimen carrier and the magnitude of the magnetic field in the predetermined region, in particular in the surface region, can at least have one local extremum, in particular a local maximum, and/or at least one saddle point. In this way the specimen can be moved to and from the local extremum by the action of the magnetic force. A targeted arrangement of the specimen is possible through the selection of the field strength and/or the position of the local extremum.

For example, the surface region can comprise a partial region in which the magnetic field lines concentrate. In other words, in this partial region the desired magnetic field arrangement has a local maximum in the magnitude of the magnetic field. This also means that the magnetic flux through the surface in this partial region can have a local maximum.

The magnetic field of the desired magnetic field arrangement can have a magnetic field component parallel and/or perpendicular to the surface region at each point or at a plurality of points in the predetermined region. In this way the specimen can be moved parallel and/or perpendicular to the surface region by the action of the magnetic force. In particular in combination with a local extremum the arrangement of the specimen can be achieved in this manner by aligning the specimen in the desired magnetic field arrangement.

The magnet device can provide a dipolar field or a quadrupolar field. In particular the magnet device can also provide a combination of a plurality of dipolar fields and/or quadrupolar fields. In combination with the relative position of the specimen carrier relative to the magnet device the magnetic field arrangement can in this way be varied or predetermined in the predetermined region.

The desired magnetic field arrangement, in particular its magnetic field line distribution, can be radially symmetrical in relation to a predetermined axis. This can be achieved, for example, if the magnet device provides a dipolar field. In particular, the predetermined axis can be perpendicular to the surface region of the specimen carrier. In this way the specimen can be arranged in a radially symmetrical surface region.

The joining of the specimen to one or a plurality of magnetic, in particular paramagnetic particles can comprise adhesion of a particle to the surface of the specimen and/or ingestion or introduction of a particle into the specimen. In particular if the specimen possesses no magnetic moment of its own, by joining the specimen to a magnetic particle the arrangement of the specimen can be realised with the aid of the action of the magnetic force of the desired magnetic field arrangement on the magnetic particle.

If the specimen corresponds to a biological cell, the particle can be ingested by the cell. In this case the magnetic particle is smaller than the cell; in particular the volume and the maximum spatial extent of the magnetic particle are smaller than the volume and the maximum spatial extent of the cell. The magnetic, in particular the paramagnetic particle can adhere to the surface of the cell. This can be achieved by positively charged end groups. The particle can then be ingested (phagocytised) by the cell. The particle can in particular be embedded in vesicles in the cytosol.

The magnetic, in particular paramagnetic particles can be coated with a polymer matrix, in particular wherein the polymer matrix is provided with a coating, which can adhere to a surface of the specimen. In this way a particle can be joined to the surface of the specimen. In this case the particle can be larger than when it is to be introduced into the specimen. In particular, if the specimen corresponds to a biological cell, a particle, for example, with a size of one fiftieth of the cell size can be used. The coating of the polymer matrix can comprise surface proteins, in particular CD molecules or activated tosyl groups. The coating can be selected such that the particle can adhere to a desired cell type, in particular only to the desired cell type.

The magnet device can comprise a permanent magnet and/or an electromagnet. The permanent magnet can in particular be a neodymium-iron-boron magnet. In this way a particularly high field strength can be achieved. For example, the maximum magnitude of the magnetic field can be between 0.5 tesla and 1.4 tesla.

An electromagnet can comprise a coil with one or a plurality of windings. In particular, the electromagnet can comprise an iron core.

The magnet device can comprise at least one tip, in particular whereby the tip comprises a magnetic, in particular a ferromagnetic material. In this way a high density of magnetic field lines, i.e. a high magnitude of magnetic field, can be provided in the region of the tip. This can be advantageous if the specimen is to be arranged in a sharply bounded surface region.

The arrangement of the magnet device relative to the specimen carrier can comprise an arrangement of the tip relative to the predetermined region. Since a high magnetic flux is provided in the region of the tip, by positioning the tip, the strength and position of the local extremum in the surface region can be determined.

The magnet device can comprise a conically shaped element, in particular whereby the conically shaped element comprises the tip. In particular an iron core of an electromagnet can comprise a tip and/or correspond to a conically shaped element.

The conically shaped element can be joined to a permanent magnet or an electromagnet, or it can be a permanent magnet or be partially arranged inside a coil of electrically conducting material, in particular whereby the coil is part of an electromagnet. The use of an electromagnet can be advantageous, because the magnetic field, in particular the magnitude of the magnetic field, can be varied in this case. In particular an electromagnet can be switched off and on. This can be of advantage particularly in the case where the method is automated.

The conically shaped element can have a diameter at the base, which corresponds to the maximum spatial extent of a permanent magnet. In particular the conically shaped element at the base can have a diameter which corresponds to the diameter of a cylindrically shaped permanent magnet or a cylindrically shaped iron core of an electromagnet. In this way an optimum joint between the conically shaped element and the permanent magnet or electromagnet can be obtained. The opening angle of the conically shaped element can be between 30° and 90°, in particular 60°.

The specimen carrier can comprise an observation region, whereby the observation region is formed such that a specimen arranged in the observation region can be observed by means of an optical device, for example a microscope. In particular the desired surface region can correspond to an observation region of the specimen carrier or an observation region can comprise the desired surface region.

The specimen carrier can comprise a bottom plate, whereby the specimen carrier lies on the bottom plate in operation and whereby the magnet device is arranged such that it is arranged underneath the bottom plate in operation, in particular whereby the tip of the magnet device is arranged directly underneath the bottom plate.

The bottom plate can comprise the desired surface region. In this case the specimen can be positioned in a desired surface region of the bottom plate.

The desired magnetic field arrangement can be formed such that a magnetic force acts on the introduced specimen, in particular on the particles joined to the specimen, so that the specimen can be moved in the desired magnetic field arrangement due to the action of the magnetic force.

In particular the magnetic force can be greater than a frictional force between the specimen and a surface of the specimen carrier. A liquid can be arranged in the specimen carrier and, if the specimen is located in the liquid, the magnetic force can be greater than a viscous frictional force between the specimen and the liquid. In this manner a specimen can be accelerated by the magnetic force. In particular the specimen can be aligned in the desired magnetic field arrangement and moved along the magnetic field lines. The magnetic force can be smaller here than the force with which the specimen and the at least one magnetic particle are joined together. In this way the specimen can be moved with the particle by force transfer.

The step of arranging the specimen can comprise moving the specimen carrier. In particular the specimen carrier can be moved such that when the specimen has contact with a surface of the specimen carrier, the specimen releases itself from the surface. This can be advantageous when the magnetic force is smaller than a frictional force between the specimen and a surface of the specimen carrier. The movement of the specimen carrier can comprise a periodic or aperiodic movement, for example shaking or pivoting the specimen carrier or vibrations due to ultrasound.

The invention also provides a method of positioning an organic, biological and/or medical specimen in a desired surface region of a specimen carrier, whereby the specimen carrier comprises a cavity, whereby a through hole leads into the cavity and whereby the through hole leads into the cavity from above when the specimen carrier is in operation, comprising the steps:

filling the cavity with a first liquid,
introduction of a second liquid into the through hole, wherein the second liquid is a hydrophobic liquid, and
introduction of the specimen into the second liquid.

In this way a specimen can be efficiently and precisely positioned, particularly in a cavity of a specimen carrier which is difficult to access.

The specimen carrier can in particular comprise one or a plurality of the features described above.

The second liquid can have a higher viscosity, a lower density and/or be more strongly hydrophobic than the first liquid. The higher viscosity can facilitate the alignment of the momentum of the introduced specimen parallel to the direction of the force of gravity. In particular the viscosity of the second liquid can be ten times to 10⁶ times the viscosity of the first liquid, in particular 10 to 1000 times or 1000 to 10⁶ times.

The lower density of the second liquid allows the second liquid to float on the first liquid and to thus remain arranged in the through hole. In particular in this way contact instability at the boundary layer between the first and the second liquid, for example Rayleigh-Taylor instability, can be reduced or prevented. For example, the density of the second liquid can be between 70% and 95% of the density of the first liquid. Alternatively or additionally, an arrangement of the second liquid in the through hole can be obtained through capillary forces.

Since the second liquid is more strongly hydrophobic, mixing of the first liquid and the second liquid can be prevented.

The first and/or second liquid can be selected such that they do not have any toxic effect on the specimen. This can be particularly advantageous if the specimen involves a living biological cell.

In particular, the first liquid can comprise water and/or the second liquid an oil, in particular a mineral oil and/or a silicone oil.

The specimen can be introduced into the second liquid in the form of a suspension, in particular whereby the suspension comprises a third liquid, whereby the third liquid is more strongly hydrophilic than the second liquid. In this way the suspension can be prevented from mixing with the second liquid.

The second liquid can be a two-component liquid, whereby the second liquid can be solidified by cross-linking or polymerisation after the step of introducing the specimen. In this way the specimen chamber can be closed. In particular, contamination of the first liquid from outside and/or evaporation of the first liquid can be prevented or reduced in this way.

The through hole can be formed such that it tapers narrowly towards the cavity. For example, the taper can be conical. A more accurate positioning of the specimen is possible through the reduction of the cross-sectional area of the through hole to the cavity.

After the filling with the first liquid, the first liquid can be arranged in the specimen carrier such that no liquid is located within the through hole. After the introduction the second liquid can be fully arranged in the through hole. In particular the second liquid can be introduced into the through hole such that the second liquid does not protrude beyond the outer opening of the through hole. In this way a secure introduction of the specimen into the second liquid can be achieved.

The invention also provides for a positioning system for positioning an organic, biological and/or medical specimen in a desired surface region of a specimen carrier, comprising a magnet device, a specimen carrier holder and a device for arranging the specimen carrier relative to the magnet device. The positioning system can in particular be used in a method described above. The specimen can be arranged precisely with the aid of a positioning system of this nature.

The specimen carrier and/or the magnet device can comprise one or a plurality of the features described above.

In particular the magnet device can comprise a permanent magnet and/or an electromagnet.

The magnet device can comprise a conically shaped, in particular a magnetic or ferromagnetic element, in particular whereby the conically shaped element comprises a tip. A high magnetic flux can be provided in the region of the tip.

The positioning system can also comprise a device for the automatic movement of the magnet device relative to the specimen carrier. In this way an at least partial automation of the specimen positioning can be achieved. In particular the device for the automatic movement can be used such that the magnet device is arranged relative to the specimen carrier so that a desired magnetic field arrangement is provided in a predetermined region of the specimen carrier. The device for the automatic movement of the magnet device can be used for the arrangement of the specimen in a desired surface region of the specimen carrier with the aid of the magnet device, in particular whereby the arrangement of the specimen comprises a movement of the magnet device relative to the specimen carrier. More precise specimen positioning can be achieved by the device for the automatic movement than with a manual execution of the process steps.

The positioning system cart comprise a device for automated movement of the specimen carrier holder, whereby the specimen carrier holder can be moved such that when a specimen has contact with a surface of the specimen carrier, the specimen can release itself from the surface. This can in particular be advantageous when the arrangement of the specimen comprises an alignment of the specimen in the desired magnetic field arrangement, whereby the magnetic force is smaller than a frictional force between the specimen and a surface of the specimen carrier. The device for the automated movement of the specimen carrier holder can in particular comprise an ultrasonic element and/or a swivel element. The ultrasonic element can induce vibrations in the specimen carrier holder, in particular with the specimen carrier fixed in it.

The positioning system can also comprise a pipetting device for, in particular automated, filling of a specimen carrier fixed in the specimen carrier holder, whereby the pipetting device can comprise one or a plurality of pipettes. With the aid of the pipetting device the introduction of the specimen into the specimen carrier can be automated and thus configured more efficiently and more precisely.

The invention also provides a specimen carrier, comprising a structural element, whereby the structural element is formed such that an organic, biological and/or medical specimen introduced into the specimen carrier can be arranged in a desired partial region, in particular in a desired surface region, of the specimen carrier. A structured specimen carrier of this nature facilitates specimen positioning in a desired surface region of the specimen carrier. A specimen carrier of this nature can in particular be used in one of the methods described above.

The specimen carrier can in particular comprise one or a plurality of the features described above.

The specimen carrier can comprise a predetermined surface region, whereby the predetermined surface region comprises the structural element, and whereby the structural element is formed such that the introduced specimen is arranged in a desired partial region of the predetermined surface region, in particular in the desired surface region.

The structural element can be formed in the shape of a prominence and/or an indentation. In particular the structural element can be formed in the shape of a dome, pyramid, groove and/or depression.

The desired partial region can border the structural element or completely surround the structural element.

In particular the structural element can comprise the desired partial region. This may be the case for example when the structural element is formed in the shape of a groove or a depression or comprises a groove and/or a depression.

The structural element can comprise a curved surface region or an inclined plane, in particular such that the introduced specimen can be directed along the curved surface region or along the inclined plane into the desired partial region. In particular, if the specimen involves a biological cell, in particular a living biological cell, it cannot grow or it can only grow with difficulty on an inclined plane or on a curved surface region. In particular, the specimen, which, after the introduction, is arranged in the curved surface region or in the inclined plane of the structural element, can be directed into a desired partial region by movement of the specimen carrier.

The specimen carrier can comprise a bottom plate, whereby the specimen carrier lies on the bottom plate in operation, and whereby the bottom plate can comprise the predetermined surface region.

In particular the desired partial region can be partially or completely planar. In this case the specimen can be stably bonded or stably positioned in the planar region of the desired partial region.

The specimen carrier can comprise a bottom plate and a cover plate, whereby the cover plate and/or the bottom plate are joined together in a manner sealed to fluids such that a cavity is formed and whereby the structural element comprises a through hole through the bottom plate or cover plate, whereby the through hole is arranged such that the specimen can be arranged in a desired partial region of the cavity.

Here, the structural element can be formed such that the specimen can be fixed in the desired partial region of the cavity by capillary forces.

The specimen carrier can comprise a plastic, in particular COC (cyclo-olefin copolymer), COP (cyclo-olefin polymer), PS (polystyrene), PC (polycarbonate) or PMMA (polymethylmetacrylate). The specimen carrier can be formed as an injection moulded part. The bottom plate can comprise a plastic and/or glass. The bottom plate can be thin, for example between 1 μm and 300 μm. In this way high resolution microscopy through the bottom plate can be facilitated.

The invention also provides a method of positioning an organic, biological and/or medical specimen in a desired surface region of the specimen carrier, comprising the steps:

provision of a specimen carrier described above,
introduction of the specimen into the specimen carrier, and
movement of the specimen carrier so that the specimen is arranged in the desired surface region of the specimen carrier.

The specimen can be arranged in the desired surface region by movement of the specimen carrier. In particular, when it is arranged in a curved partial region or an inclined plane of the structural element, the specimen can be directed into the desired surface region by the movement.

The invention also provides a method of positioning an organic, biological and/or medical specimen in a desired surface region of a specimen carrier, comprising the steps:

provision of a specimen carrier, whereby the specimen carrier comprises a bottom plate and a cover plate, whereby the cover plate and/or the bottom plate are joined together in a manner sealed to fluids such that a cavity is formed and whereby the structural element comprises a through hole through the bottom plate or cover plate, whereby the through hole is arranged such that the specimen can be arranged in a desired partial region of the cavity, and
introduction of the specimen in the form of a suspension into the specimen carrier.

The specimen carrier can in particular comprise one or a plurality of the features described above.

Here, the structural element can be formed such that the specimen can be held in the desired partial region of the cavity by capillary forces.

A gel can be introduced into the desired partial region of the cavity before the step of introducing the specimen. In particular a Collagen 1 gel, an agarose gel or a matrigel can be used.

After the introduction of the specimen the through hole can be closed, in particular with an optically transparent material.

### BRIEF DESCRIPTION OF THE DRAWINGS

Further features and advantages are explained in the following based on exemplary figures.

FIG. 1 shows an example of a specimen carrier with a structural element in the shape of a dome;

FIG. 2 shows an example of a specimen carrier and a structural element in the shape of a prominence;

FIG. 3 shows an example of a specimen carrier with a structural element in the shape of a prominence and introduced specimens;

FIG. 4 shows an example of a specimen carrier and a structural element in the shape of a prominence;

FIG. 5 shows an example of a specimen carrier with a structural element in the shape of a prominence and introduced specimens;

FIG. 6 shows an example of a specimen carrier with a structural element in the shape of a prominence and introduced specimens;

FIG. 7 shows an example of a specimen carrier with a′structural element in the shape of a prominence and introduced specimens;

FIG. 8 shows an example of a specimen carrier with a structural element in the shape of a prominence and introduced specimens;

FIG. 9 shows an example of a specimen carrier with a structural element in the shape of a prominence and an optical device;

FIG. 10 shows an example of part of a specimen carrier with structural elements in the shape of prominences;

FIG. 11 shows an example of a specimen carrier and a structural element comprising a through hole through a cover plate;

FIG. 12 shows an example of a specimen carrier and a structural element comprising a through hole through a cover plate;

FIG. 13 shows an example of a specimen carrier and a structural element comprising a through hole through a cover plate;

FIG. 14 shows an example of a specimen carrier with a structural element comprising a through hole through a cover plate and a gel in a partial region of the specimen carrier;

FIG. 15 shows an example of a specimen carrier with a structural element comprising a through hole through a cover plate and introduced specimens;

FIG. 16 shows an example of a specimen carrier with a structural element comprising a through hole through a cover plate and a gel in a partial region of the specimen carrier;

FIG. 17 shows an example of part of a specimen carrier, introduced specimens and a magnet device;

FIG. 18 shows an example of part of a specimen carrier, introduced specimens and a magnet device;

FIG. 19 shows an example of part of a specimen carrier, introduced specimens and a magnet device;

FIG. 20 shows an example of part of a specimen carrier, introduced specimens and a magnet device;

FIG. 21 shows an example of part of a specimen carrier, introduced specimens and a magnet device; and

FIG. 22 shows an example of part of a specimen carrier, introduced specimens and a magnet device.

### DETAILED DESCRIPTION OF THE INVENTION

The organic, biological and/or medical specimen can be a biological cell. In particular a plurality of cells can be positioned. In this way a desired cell distribution in a desired surface region of the specimen carrier can be provided.

Generally, when filling a specimen carrier or culture container a random distribution of the cells occurs. In the case of simple dishes or jars the cell distribution often depends on the type of filling, i.e. for example, how quickly the cell suspension is pipetted in and how the containers are moved directly after filling. In microfluidic cell culture containers the cell distribution often depends on the geometry of the structures which take up the cell suspension.

In particular with experiments with biological cells often exact positioning of the cells is required. In this way the local cell density can be defined in order to be able to easily compare results from different experiments against one another, to be able to carry out the experiments economically and/or to simplify the evaluation or to facilitate automation of the evaluation. For example, with a microscopic assay it is not always necessary that cells occupy the complete surface region of a specimen carrier, but rather it is sufficient if cells are arranged just in the optically accessible region or a part of it. In this way rare or expensive cell material can be saved. In certain cases it can be advantageous if cells adhere only to certain locations and the complete observation region is not occupied. In this case fewer cells consume the medium or gas which is available. Thus, it is also possible to cultivate cells under static conditions in extremely flat or small structures.

For example, the migration of adherent cells can be measured in that the chronological development of the shape of an initially circular arrangement of cells is observed in a suitable gradient of the concentration of a chemical substance. If the shape remains homogeneously circular over time, then the cells show no aligned movement, but in contrast if the shape extends more strongly in the direction of the gradient than in the direction perpendicular to it, then an aligned movement is indicated.

A specimen carrier can comprise a plastic, in particular COC, COP, PS, PC or PMMA. An example of a specimen carrier is described in DE 101 48 210. The specimen carrier can correspond to an injection moulded part or comprise an injection moulded part. The specimen carrier can comprise a bottom plate and a cover plate. A cavity or a region open at the top can be formed by joining the bottom plate to the cover plate. An opening can lead into the cavity, in particular whereby the opening can be used for filling or emptying the cavity, for example with the specimen. The bottom plate can for example be joined by means of fusing with or gluing to the cover plate. In particular, glass can be applied by gluing. For adhesives, for example, UV-curable adhesives, adhesive strips or other means of gluing can be used. Here, in particular substances are used which do not have a toxic effect on the specimen. Suitable welding technologies are described in EP 1 579 982.

The specimen carrier, in particular the bottom plate, can comprise a structural element, in particular a three-dimensional structural element. The structural element can be formed in the shape of a prominence and/or an indentation. The structural element can be used for specimen positioning, for example, since a specimen cannot grow onto a prominence in the shape of a tip or rounded dome, because it drops down vertically or along an inclined plane.

Alternatively or additionally, an indentation can also be formed in the shape of a groove, for example, in which the specimen can be positioned. In this way biological cells, for example, can be locally concentrated in a desired partial region.

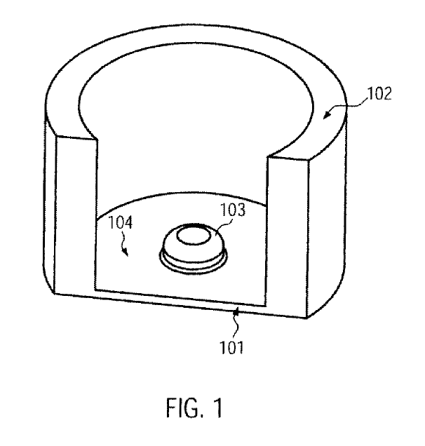

FIG. 1 shows a specimen carrier comprising a bottom plate 101 and a cover plate 102, which are joined together such that a region open at the top is provided. A cut-out on the side of the figure facing the observer is provided for clarity. Structural element 103 is formed in the shape of a prominence, in particular in the shape of a dome. The internal diameter of the specimen carrier can be 7 mm. The structural element can have a diameter of 2 mm, a radius of curvature of the top edge of 0.5 mm and a height of 1 mm. The structural element can be provided, for example, by deep drawing in the bottom plate 101.

One or a plurality of specimens can be introduced into the specimen carrier. For example, the specimen carrier can be filled with 100 μl of cell suspension, in particular whereby the concentration or number density of the cells in the suspension can be selected such that a desired surface region 104 can be occupied up to 100% confluence with cells. 100% confluence means that no free area between the cells is visible. After the introduction of the cell suspension, for example after 30 seconds, the specimen carrier can be alternately moved diagonally in opposite directions, so that cells, which have settled on the structural element 103, are directed in the desired surface region 104.

A specimen carrier according to FIG. 1 can be used for a migration assay. To evaluate the migration behaviour of biological cells a picture of the specimen carrier can be taken after a specified time, for example after two hours, and the confluence of the cells be evaluated. The confluence gives in percent the ratio of the area occupied with cells to the total area of the surface region of the specimen carrier provided for the migration assay. Based on the measured data the time can be determined, which is necessary in order, for example, for a flat upper region of the structural element 103 to increase to 100% confluence.

Compared to known migration assays, this migration assay has decisive advantages. With the known scratch assay for example, a cell-free region is scratched with the tip of a pipette in a surface region overgrown with cells and the time is measured which is needed by the cells to close the scratch again. Problems in the reproducibility can in part arise in that the scratch generally has no well defined width and in that possible surface coatings of the specimen carrier are destroyed or damaged by the scratch.

Alternatively, a region free of a specimen can be maintained, in that it is covered with a silicone part, which is either mechanically pressed onto the growth surface or is held in a self-adhesive manner on the growth surface by an adhesive layer. Experimental arrangements, which apply silicone parts to produce cell-free regions in confluent cell cultures, have the disadvantage that the silicone parts must be removed before the actual assay and generate an additional risk of contamination. In addition, coating proteins can also adhere to the silicone, which can interfere with any existing protein coating of a surface region of the specimen carrier. Due to the relatively high elasticity of the silicone, the accuracy of the size of the area left free is restricted.

A specimen carrier as illustrated in FIG. 1 comprises no movable parts in contact with the specimen. The dimensioning of the structural element 103 can, for example, be reproducible due to an appropriately optimised deep-drawing process.

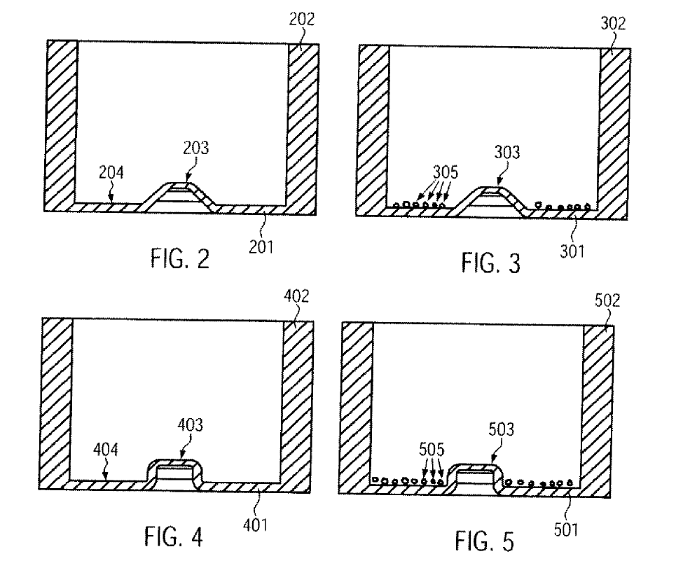

FIGS. 2 to 5 each illustrate a cross-section through a specimen carrier with a structural element 203, 303, 403 or 503. The structural element 203 or 303 in FIGS. 2 and 3 is formed in the shape of a pyramid. In this way the structural element 203 or 303 comprises a plurality of inclined planes. In particular, the structural element 203 or 303 in FIGS. 2 and 3 is a truncated pyramid, i.e. the tip is flattened.

FIGS. 4 and 5 illustrate a structural element 403 or 503 in the shape of a dome with vertical walls.

In FIGS. 3 and 5 single specimens 305 or 505 are illustrated, which are arranged in a desired surface region.

The specimen carrier comprises in each case a bottom plate 201, 301, 401 or 501 and a cover plate 202, 302, 402 or 502.

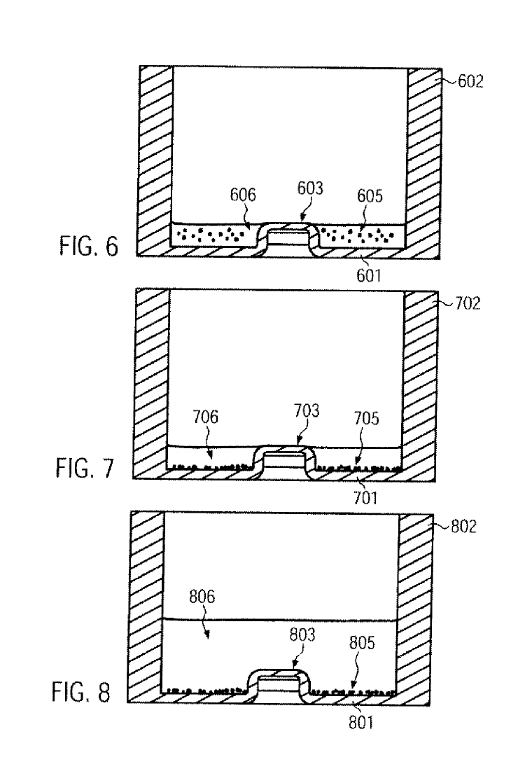

FIGS. 6 to 8 each illustrate a cross-section through a specimen carrier comprising a structural element 603, 703 or 803. The specimens 605, 705 or 805 are arranged in a medium 606, 706 or 806, in particular a liquid. In FIG. 6 the filling level of the liquid 606 corresponds to the height of the structural element 603. FIG. 7 illustrates the specimen carrier from FIG. 6 at a later point in time, whereby the specimens 705 are arranged in a desired surface region of the specimen carrier. In other words the specimens 705 have settled on the bottom of the specimen carrier to which they have adhered. FIG. 8 illustrates the specimen carrier from FIGS. 6 and 7, whereby the specimen carrier is filled to a predetermined filling level with the medium 806.

The specimen carrier comprises in each case a bottom plate 601, 701 or 801 and a cover plate 602, 702 or 802.

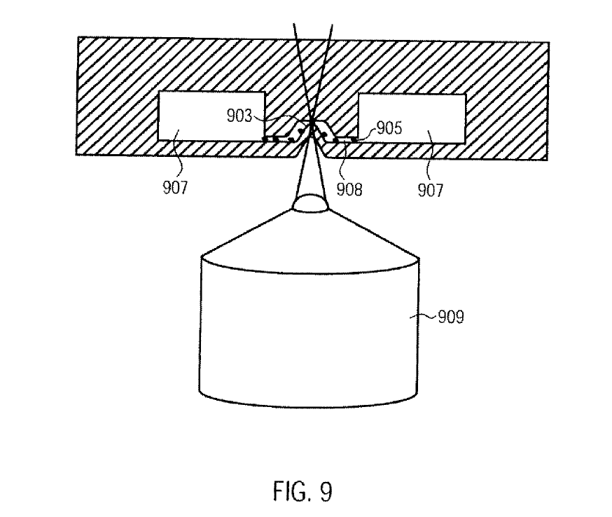

FIG. 9 illustrates a specimen carrier comprising a cavity 907, whereby the cavity 907 comprises an observation channel 908. A structural element 903 is arranged in the observation channel 908. A specimen carrier as in FIG. 9 can be used for a chemotactic experiment. To do this, a gradient of a chemical substance is established between two partial regions of the cavity 907, for example in that only a partial region of the cavity 907 is filled with this chemical substance. An optical system 909, in particular a microscope, can be used to observe the movement of the specimens 905, in particular living biological cells. The focus of the observing optical system 909 can be adjusted such that only specimens, which are arranged at the highest point of the structural element 903 produce a sharp image. To achieve this, the structural element 903 can comprise a round or flattened tip.

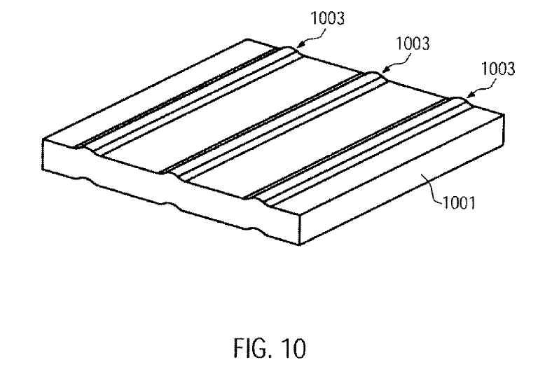

FIG. 10 illustrates a surface region of a specimen carrier, in particular a surface region of a bottom plate 1001, comprising three structural elements 1003, whereby each of the structural elements 1003 is formed as an elongated prominence. It is also possible to use structural elements in the shape of elongated indentations or to combine elongated prominences with indentations, for example with depressions with different diameters. The height and width of the strip-shaped structural elements can be varied.

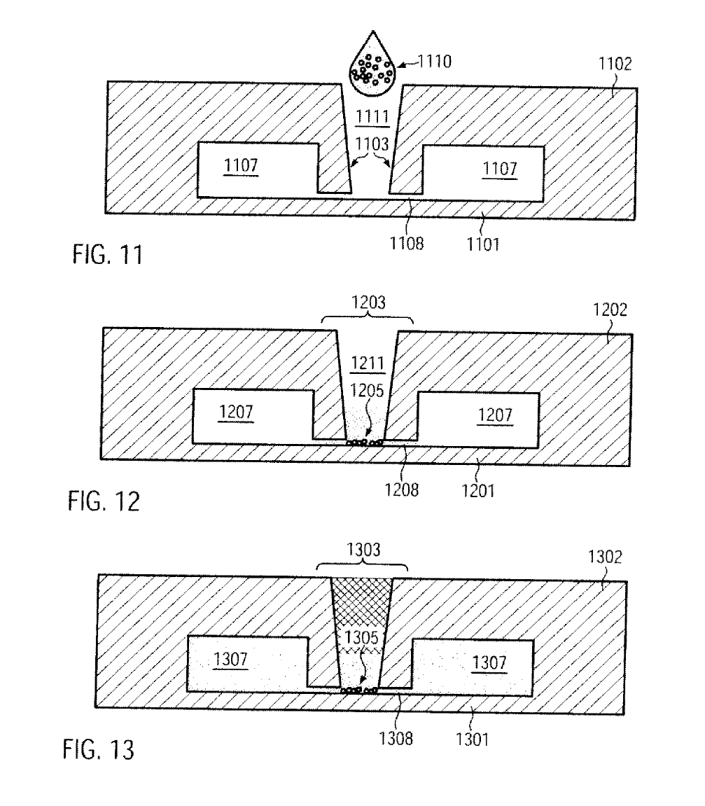

FIGS. 11 to 13 illustrate a specimen carrier comprising a cavity 1107, 1207 or 1307, a bottom plate 1101, 1201 or 1301 and a cover plate 1102, 1202 or 1302 joined to the bottom plate 1101, 1201 or 1301. A structural element 1103, 1203 or 1303 comprises an opening 1111 or 1211 in the cover plate 1102, 1202 or 1302. The opening 1111 or 1211 is in particular conically formed, in particular whereby the opening 1111 or 1211 tapers narrowly towards the bottom plate 1101, 1201 or 1301. A specimen 1205 or 1305 in the shape of a suspension 1110 can be introduced into the specimen carrier through the opening 1111 or 1211 (refer to FIG. 11). The amount of suspension can be dimensioned such that, as illustrated in FIG. 12, the observation region 1208 is filled and a part of the suspension 1110 is arranged in the opening 1211. An emergence of liquid from the observation region 1108, 1208 or 1308 into a first or second partial region of the cavity 1207 is prevented by capillary effects. The specimens can settle and adhere on the bottom of the observation region 1108, 1208 or 1308 in the region of the opening 1111 or 1211. The cavity 1107, 1207 or 1307 can be filled after adhesion. The opening 1111 or 1211 can be closed and sealed with an optically transparent material, for example, PDMS (polydimethylsiloxane, e.g. Sylguard 184, Dow Corning Corporation). A filled specimen carrier with closed opening is illustrated in FIG. 13.

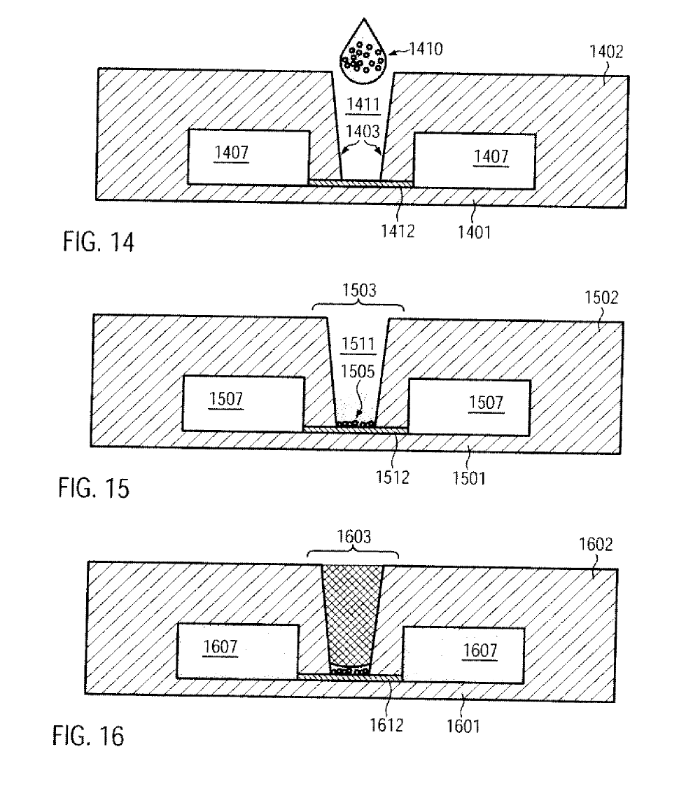

FIG. 14 illustrates a specimen carrier comprising an observation region, whereby a piece of gel 1412, for example Collagen 1 gel, agarose gel or matrigel (for example from Becton Dickinson) is arranged in the observation region. If the specimen 1505 (in the form of a suspension 1410) is put into the specimen carrier, as illustrated in FIGS. 15 and 16, it sinks to the gel surface, where it adheres and can migrate or sink into the gel. In this way the cells can be arranged in a spatial area above the desired surface region. In other words a three-dimensional distribution of the specimens in the gel can be achieved for a plurality of specimens. In addition FIGS. 14 to 16 illustrate a specimen carrier comprising a bottom plate 1401, 1501 or 1601, a cover plate 1402, 1502 or 1602, a cavity 1407, 1507 or 1607, and a structural element 1403, 1503 or 1603. A piece of gel 1412, 1512 or 1612 is arranged in the observation region. In FIGS. 14 and 15 an opening 1411 or 1511 in the structural element 1403 or 1503 is illustrated in the shape of a through hole through the cover plate 1402 or 1502.

The following method is suitable for positioning a specimen in a specimen carrier comprising a cavity and an opening, which leads into the cavity.

An opening, which leads into the cavity from the outside, can be located above the desired surface region of the specimen carrier, in particular above an observation region of the specimen carrier. Firstly, the cavity can be filled with a medium, in particular whereby the medium does not extend above the height of the cavity into the opening. The medium can comprise a culture medium for biological cells and in particular correspond to a first liquid. The opening can be closed with a second liquid, in particular a drop of oil, for example silicone oil or mineral oil, whereby only so much is added that the oil surface does not bulge upwards. The specimen can be placed on the oil in the form of a suspension. The specimen drops through the oil onto the desired surface region where it can adhere or grow. The specimen can be accurately positioned in this way. In particular a plurality of specimens can be positioned, whereby the number of specimens is accurately adjustable. In this way a lower number of specimens can be used and the specimen can also be positioned in surface regions of the specimen carrier which are difficult to access.

In particular experimental preparations can be made before the introduction of the specimen. For example, a concentration gradient in the specimen carrier can be established before the specimen is introduced into the specimen carrier. The idea is that specimens, in particular cells, are only introduced into an experimental environment when all or a large part of the experimental parameters, for example the gradient of a chemical substance, the temperature, the gas concentration in the medium and/or the pH value are adjusted. This means that cells are not disturbed by the preparations for the experiment, which for example can occur due to a change of solution, vibrations or temperature variations. In this way, the cells can be in a (maximum) comparable condition at the start of the experiment. Immediately after introduction the cells can be situated in the desired gradient, so that the reaction of the cells can be observed without a time delay. Also slightly or non-adherent cells, i.e. cells which do not adhere to a surface of the specimen carrier, can be examined using this method. Examples of this are immune cells, for example neutrophils and other leukocytes. Since the oil as far as possible prevents evaporation of the first liquid, in particular a small quantity of a medium can be used.

For example, a specimen carrier, comprising two reservoirs and an observation channel arranged between them, such as described, for example, in EP 1 741 487, can be filled with specimens. To do this, the specimen carrier is first filled with a neutral medium. Then a gradient of a chemical substance is established between the reservoirs. Since this can take a certain time, in particular a few hours, it is possible with this method to introduce the specimen into the gradient only when it is completely established. An opening, which for example is formed conically and is closed with a hydrophobic liquid, can be located directly above the observation channel. The hydrophobic liquid may involve, for example, a silicone oil or a mineral oil, in particular whereby the oil is selected such that it does not have a toxic effect on the specimen and does not attack or destroy the materials of the specimen carrier. As a hydrophobic liquid, a two-component liquid can be used, which is introduced into the filling opening only shortly before the specimen is introduced and can then be polymerised or otherwise cross-linked and solidified. Examples here are silicone oils, which are mixed with cross-linkers or for example Sylguard 184 from Dow Corning (PDMS). Once the specimen has been introduced, the observation, for example with the aid of a microscope, can be carried out.

Positioning of a specimen in a desired surface region of a specimen carrier can be carried out by means of a magnetic force. To achieve this, the specimen must exhibit magnetic properties and be subjected to magnetic forces in an appropriate specimen carrier. Biological cells normally have no magnetic properties. In order to be able to magnetically manipulate cells as a specimen, they must be “magnetised”. In this respect paramagnetic particles, for example, are suitable, in particular paramagnetic nanoparticles. The particles can be joined to the specimen in various ways. Small particles can be phagocytised, i.e. ingested, by the cells. A prerequisite for the ingestion is the deposition of the particles on the cell surface. Positively charged end groups are particularly suitable for deposition on the surface of the cell, because the cell membrane usually bears a negative charge. The particles can be in particular embedded in vesicles in the cytosol. With an appropriate quantity of ingested particles the external influence of a magnetic field can be large enough to move a non-adherent cell in a specimen carrier.

Another method is binding the particles to the cell surface. In this connection the magnetic particles can be larger, i.e. almost as large as the cell itself or larger. In particular the size of a particle can correspond to a fiftieth of the cell size. In their core the particles can consist of a paramagnetic material, for example, and can be coated with a polymer matrix. On this polymer matrix the particles can have a coating which can adhere to a cell surface. Examples in this respect are surface proteins such as CD molecules or activated tosyl groups. The binding of the particles to the cells can be specific or non-specific due to the choice of the coating. In particular the coating can be selected such that it only adheres to one type of cell, i.e. it is specific. In this way a desired type of cell can be filtered out of a plurality of cells.

In order to exert a force on the specimen, in particular on a cell, a magnetic field can be applied, in particular perpendicular to the potential movement direction, for example to the growth surface of the specimen carrier. To concentrate a plurality of specimens in a defined, radially symmetrical surface region, a field can for example be applied, the field lines of which are concentrated towards the desired surface region. If a round cell spot is required, the field in this region can be the strongest and the field lines can be less concentrated in concentric circles around the desired surface region. This can be achieved, for example, with an iron cone, the tip of which is placed directly under the desired surface region.

FIGS. 17 to 20 illustrate a part of a specimen carrier, in particular an observation channel 1708; 1808, 1908 or 2008, comprising a bottom plate 1701, 1801, 1901 or 2001 and a cover plate 1702, 1802, 1902 or 2002. A cone or conically formed element 1713, 1813, 1913 or 2013 of a magnetically or magnetisable material is joined to a permanent magnet 1714, 1814, 1914 or 2014. The permanent magnet 1714, 1814, 1914 or 2014 can be for example a neodymium-iron-boron (NdFeB) magnet. The magnitude of the field strength of the permanent magnet 1714, 1814, 1914 or 2014 can be between 0.5 and 1.4 tesla. The magnetic field is bundled towards the tip of the conical element 1713, 1813, 1913 or 2013 and a magnetic field line distribution is produced in which the field lines at the tip of the conically shaped element 1713, 1813, 1913 or 2013 are strongly concentrated. The permanent magnet 1714, 1814, 1914 or 2014 can have a diameter between 1 mm and 20 mm, in particular 3 mm to 10 mm. The conically shaped element 1713, 1813, 1913 or 2013 can have a diameter at the base, which corresponds to the diameter of the permanent magnet 1714, 1814, 1914 or 2014. The opening angle of the conically shaped element 1713, 1813, 1913 or 2013 can be between 30° and 90°, in particular 60°. For positioning a specimen in an observation channel 1708, 1808, 1908 or 2008 of for example 1 mm width and 70 μm height, a conically shaped element 1713, 1813, 1913 or 2013 with a diameter of the base area of 4 mm is suitable. Towards the top the conically shaped element 1713, 1813, 1913 or 2013 can narrowly taper to a flattened tip, whereby the flattened region can have a diameter of 0.5 mm.

The opening angle of the conically shaped element 1713, 1813, 1913 or 2013 can be 60°. The permanent magnet 1714, 1814, 1914 or 2014 can have a diameter and a height of 4 mm. Instead of a permanent magnet 1714, 1814, 1914 or 2014, an electromagnet can also be used. This can be of advantage for automation of the method, because the magnetic field of an electromagnet varies and can in particular be switched on and off.

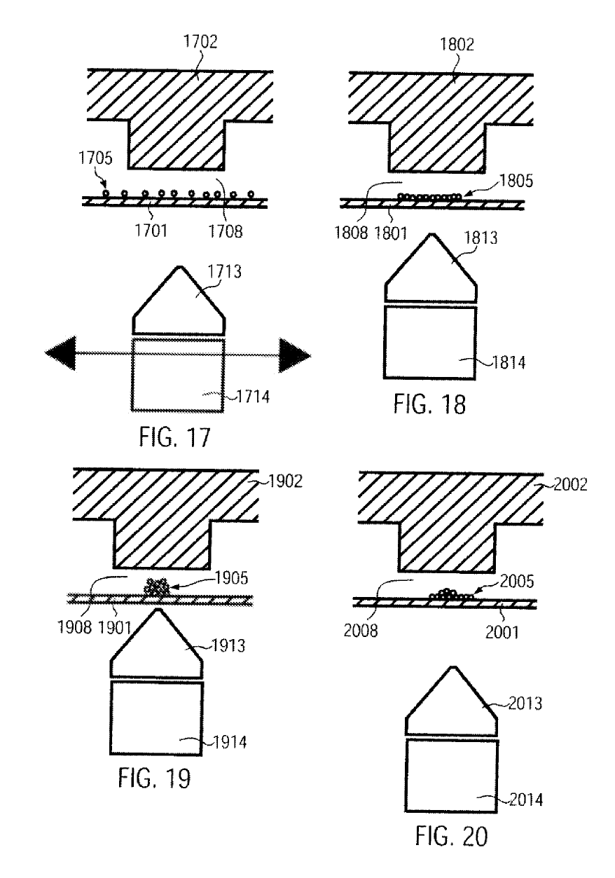

The magnet device can be positioned relative to the specimen carrier. In particular the position of the magnet device can be changed in parallel to the specimen carrier, as indicated in FIG. 17, or perpendicular to it, as illustrated in FIGS. 18-20. For example, the desired magnetic field arrangement, in particular the strength of the local extremum of the magnitude of the magnetic field, can be varied by the perpendicular distance to the specimen carrier. FIGS. 18 to 20 illustrate the magnet device at various distances to the specimen carrier. In this way the diameter of the desired surface region can be varied in that the specimens 1705, 1805, 1905 or 2005 are arranged.

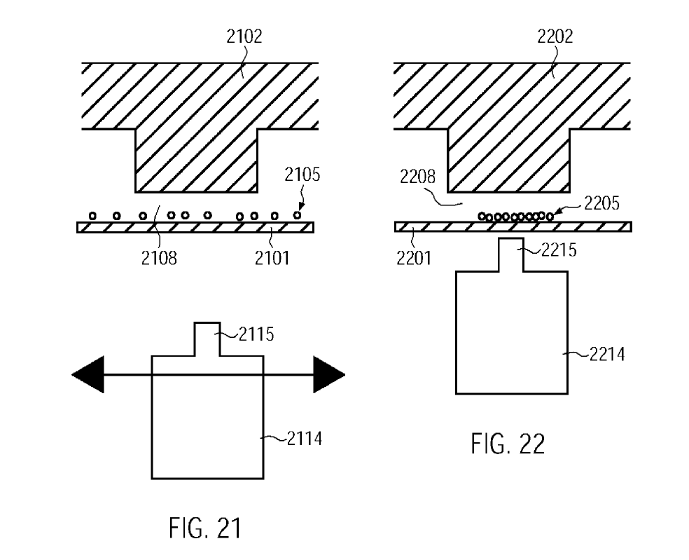

FIGS. 21 and 22 illustrate a magnet device 2114 or 2214 and a part of a specimen carrier, in particular an observation channel 2108 or 2208, comprising a bottom plate 2101 or 2201 and a cover plate 2102 or 2202. The magnet device 2114 or 2214 has a tip 2115 or 2215 in the shape of a cuboid extension. As indicated in FIG. 21, the magnet device can be positioned relative to the specimen carrier. In particular the size of the desired surface region can be determined by the perpendicular distance of the tip 2115 or 2215 of the observation channel 2108 or 2208. For example, FIG. 22 illustrates that when the tip 2115 or 2215 is positioned closer to the observation channel 2108 or 2208, the specimens 2105 or 2205 are arranged in a smaller surface region of the specimen carrier. This can be explained by a more strongly formed local extremum of the magnitude of the magnetic field of the desired magnetic field arrangement.

The specimens can, for example be introduced into the specimen carrier in a suspension whereby the number density of the specimens in the suspension corresponds to the desired cell density. The suspension can be introduced with a pipette, whereby the complete liquid of the suspension can flow over the position of the peak of the magnetic field. In this respect the cells are held fixed in the magnetic field, but not immediately concentrated at the peak. This method can be used for observation channels. In this case with suitable positioning of the magnet device, the liquid is forcibly flushed past the desired magnetic field arrangement.

To compress the specimens in the desired surface region the specimens are set in motion by small impacts or vibrations before they can adhere to a surface region of the specimen carrier. The specimens, in particular the cells, move in the direction of the intensifying field lines. In other words they can be gradually shaken to a maximum of the magnetic field. The movement or small impacts can be obtained by vibrations on a shaker, by ultrasound or by swiveling the specimen carrier.

Once the specimen is positioned, the complete experimental set-up, in particular the specimen carrier with the introduced specimen and the magnet device, can be placed in an incubator for adhesion. This may take several hours. The magnet device can be removed only after this period.

The methods and/or specimen carriers described above can be combined in any manner.

For example, a specimen carrier for chemotactic examinations can be used in which the migration of cells in a gradient is to be observed. Here, an analysis is to be made of whether cells migrate to a greater or lesser extent in the direction of increasing concentration of a substance. In this respect closable reservoirs can be connected by an observation channel, whereby the height of the observation channel is less than 10% of the height of the reservoirs, for example 70 μm for a reservoir height of 800 μm. The reservoirs can be filled with cells and solutions via openings.

A groove in the bottom plate can be incorporated in the centre of the observation channel perpendicular to the joining line of the reservoirs, whereby the profile of the groove has a maximum height of, for example, 100 μm and a maximum width of, for example, 100 μm. The length of the groove can correspond to the width of the observation channel. First both reservoirs can be filled with a neutral liquid. The neutral liquid can correspond to a liquid culture medium for cells. Then cells are introduced into one of the reservoirs, which for example are rendered magnetic by phagocytosis of magnetisable particles. Then a permanent magnet can be arranged underneath the reservoir filled with cells. This magnet can then be moved in the direction of the second reservoir. As this occurs, the cells follow the movement of the magnet device until they are held back in the groove. Here the cells can be allowed to adhere. Then a gradient of a chemical substance can be established in the observation channel.

As an alternative to the groove, also a plurality of round indentations with peaked bottoms or a flat, horizontal bottom can be incorporated. In this case the magnetic cells can be introduced into the indentations through the systematic movement of the specimen carrier relative to the magnet. Here, the maximum radii of the indentations can be, for example, 50 μm to 1 mm, and the maximum depth of the indentations can be approx. 5 μm to 100 μm.

Instead of introducing the cells into indentations, a structure protruding from the bottom plate can also be produced, for example, by deep drawing or hot embossing of a plastic film. The structural element can correspond to a rectangular barrier, the longitudinal direction of which is located perpendicular on the joining line of both reservoirs. The width of the barrier can appropriately correspond to the maximum distance traveled by a cell during the observation period. Typical observation periods are for example 12 or 24 hours. For example, in 12 hours human endothelial cells, such as for example HUVEC, cover on average 200 μm in the direction of a well-marked gradient or 400 μm in 24 hours. On a length of approx. 200 μm to 400 μm the migration of many cell types of mammals is analysed and assessed with regard to chemotaxis. Therefore a barrier width between 50 μm and 1000 μm can be selected.

The experiment can be carried out such that cells are introduced into the observation channel and removed from the barrier-shaped structural element by tilting the specimen carrier. With the aid of a magnet device cells can be positioned in a partial region or removed from a partial region which borders the barrier-shaped structural element. Observation of the migration of the cells can take place by means of video microscopy. In this way it can be determined whether significantly more cells migrate in the direction of the increasing or decreasing concentration of the chemical substance. The barrier width can here also be smaller than 50 μm. In particular the structural element can comprise not a flat region but rather, for example, only a curved region. If the cells are fluorescent due to a GFP construct (Green Fluorescent Protein construct), the cells crossing the barrier can be rendered visible by suitable focussing when they are in the vicinity of the highest region of the structural element.

Alternatively, for example at the end of the observation period, a single picture can be produced and the cell distribution on the structural element evaluated. To do this, strips of the width of a cell diameter can be superimposed on the region of the structural element by means of image processing, whereby the strips run in the longitudinal direction of the barrier. The number of cells per strip can be counted and the number of cells can be plotted versus the respective distance of the strip from one end of the barrier. If the observation period is selected such that the cells can as a maximum move to the centre of the structural element, then for example a higher cell density on the barrier side, which faces the direction of the falling gradient, is an indication of chemotactic activity.

It is self-evident that the features mentioned in the previously described embodiments are not restricted to these particular combinations and are possible in any other combinations. In particular different specimen carriers with different methods of positioning an organic, biological and/or medical specimen can be combined.

1. Method of positioning an organic, biological and/or medical specimen in a desired surface region of a specimen carrier, wherein a magnet device is provided, comprising the steps:
joining the specimen with one or a plurality of magnetic, in particular paramagnetic particles;
arrangement of the magnet device relative to the specimen carrier so that a desired magnetic field arrangement is provided in a predetermined region of the specimen carrier;
introduction of the specimen into the specimen carrier; and
arrangement of the specimen in the desired surface region with the aid of the magnet device.

2. Method according to claim 1, wherein the arrangement of the specimen comprises aligning the specimen in the desired magnetic field arrangement.

3. Method according to claim 1, wherein the arrangement of the specimen comprises a movement of the magnet device relative to the specimen carrier.

4. Method according to claim 1, wherein the predetermined region of the specimen carrier comprises the desired surface region.

5. Method according to claim 1, wherein the desired magnetic field arrangement comprises a magnetic field, a magnetic flux and/or a magnetic field line distribution.

6. Method according to claim 5, wherein the predetermined region of the specimen carrier comprises a surface region of the specimen carrier and wherein the magnitude of the magnetic field in the predetermined region, in particular in the surface region, has at least one local extremum, in particular a local maximum, and/or at least one saddle point.

7. Method according to claim 1, wherein the joining of the specimen to one or a plurality of magnetic, in particular paramagnetic particles comprises an adhesion of a particle to the surface of the specimen and/or ingestion or introduction of a particle into the specimen.

8. Method according to claim 1, wherein the magnet device comprises a permanent magnet and/or an electromagnet.

9. Method according to claim 1, wherein the magnet device comprises at least one tip, in particular wherein the tip comprises a magnetic, in particular a ferromagnetic material.

10. Method according to claim 1, wherein the desired magnetic field arrangement is formed such that a magnetic force acts on the introduced specimen, in particular on the particles joined to the specimen, so that the specimen can be moved in the desired magnetic field arrangement by the action of the magnetic force.

11. Method according to claim 10, wherein the magnetic force is greater than a frictional force between the specimen and a surface of the specimen carrier and/or wherein a liquid is arranged in the specimen carrier and wherein, when the specimen is located in the liquid, the magnetic force is greater than a viscous frictional force between the specimen and the liquid.

12. Method according to claim 1, wherein the step of arranging the specimen comprises a movement of the specimen carrier, in particular so that, when the specimen has contact with a surface of the specimen carrier, the specimen releases itself from the surface.

13. Method, in particular according to claim 1, of positioning an organic, biological and/or medical specimen in a desired surface region of a specimen carrier, wherein the specimen carrier comprises a cavity, wherein a through hole leads into the cavity and wherein the through hole leads into the cavity from above when the specimen carrier is in operation, comprising the steps:
filling the cavity with a first liquid;
introduction of a second liquid into the through hole, wherein the second liquid is a hydrophobic liquid; and
introduction of the specimen into the second liquid.

14. Method according to claim 13, wherein the second liquid has a higher viscosity, a lower density and/or is more strongly hydrophobic than the first liquid.

15. Method according to claim 13, wherein the first liquid comprises water and/or the second liquid comprises an oil, in particular a mineral oil or a silicone oil.
